(19) United States
(12) Patent Application Publication
(10) Pub. No.: US 2017/0046801 A1
(43) Pub. Date: Feb. 16, 2017

(54) MANAGING THE SIZE OF FOOD PORTIONS

(71) Applicant: International Business Machines Corporation, Armonk, NY (US)

(72) Inventors: Donna K. Byron, Petersham, MA (US); Carmine M. DiMascio, West Roxbury, MA (US); Florian Pinel, New York, NY (US); Timothy P. Winkler, Clinton, MA (US)

(21) Appl. No.: 14/824,203

(22) Filed: Aug. 12, 2015

(51) Int. Cl. G06Q 50/12; G06N 99/00; G06Q 30/06

(52) U.S. Cl. CPC G06Q 50/12; G06Q 30/0621; G06N 99/005

(57) ABSTRACT

One or more attributes for a customer are determined. A food portion for the customer is determined using a machine learning model and the one or more attributes. A food waste for the customer is determined. The machine learning model is updated based on the food waste for the customer and the one or more attributes for the customer.

### BACKGROUND OF THE INVENTION

The present invention relates generally to the field of food services, and more particularly to managing food portion sizes.

### SUMMARY

Embodiments of the present invention include a method, computer program product, and system for managing food portion sizes. In one embodiment, one or more attributes for a customer are determined. A food portion for the customer is determined using a machine learning model and the one or more attributes. A food waste for the customer is determined. The machine learning model is updated based on the food waste for the customer and the one or more attributes for the customer.

### BRIEF DESCRIPTION OF THE DRAWINGS

FIG. 1 is a functional block diagram of a data processing environment, in accordance with an embodiment of the present invention;

FIG. 2 is a flowchart depicting operational steps for managing food portion sizes, in accordance with an embodiment of the present invention; and

FIG. 3 depicts a block diagram of components of the computer of FIG. 1, in accordance with an embodiment of the present invention.

### DETAILED DESCRIPTION

Embodiments of the present invention provide for determining a food portion size for a user using a machine learning model. Embodiments of the present invention determine which food portion sizes should be reduced or increased, by how much the food portions sizes should be reduced or increased by and who the food portion sizes should be reduced or increased for. Embodiments of the present invention recognize that food is often wasted after a person is done consuming their allotted portion of food. Embodiments of the present invention recognize that restaurants and caterers may reduce food waste be reducing served portion sizes. Embodiments of the present invention recognize that reducing portion sizes and subsequently reducing food waste may lead to a reduced food cost and labor cost without reducing revenue. Embodiments of the present invention recognize that reducing food portion sizes for a consumer by too large of an amount may lead to unhappy consumers. Embodiments of the present invention recognize that often a person wishes they had a larger portion of food to consume. Embodiments of the present invention recognize that increase food portions sizes for a consumer to a proper amount may lead to happy consumers because the customer will not have to order an additional portion. Embodiments of the present invention recognize that a customer may order an additional portion and the amount of food waste of the additional portion would be recorded and analyzed.

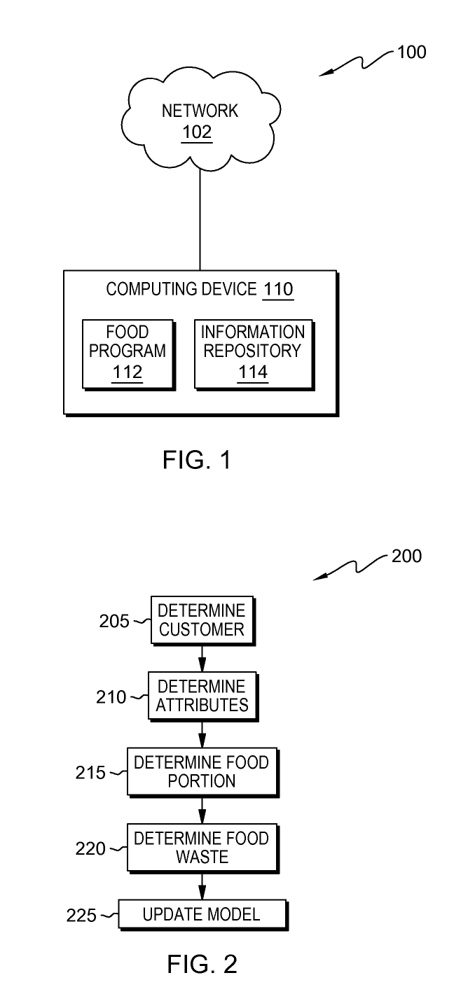

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes computing device 110 connected to network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between computing device 110 and any other computer connected to network 102, in accordance with embodiments of the present invention.

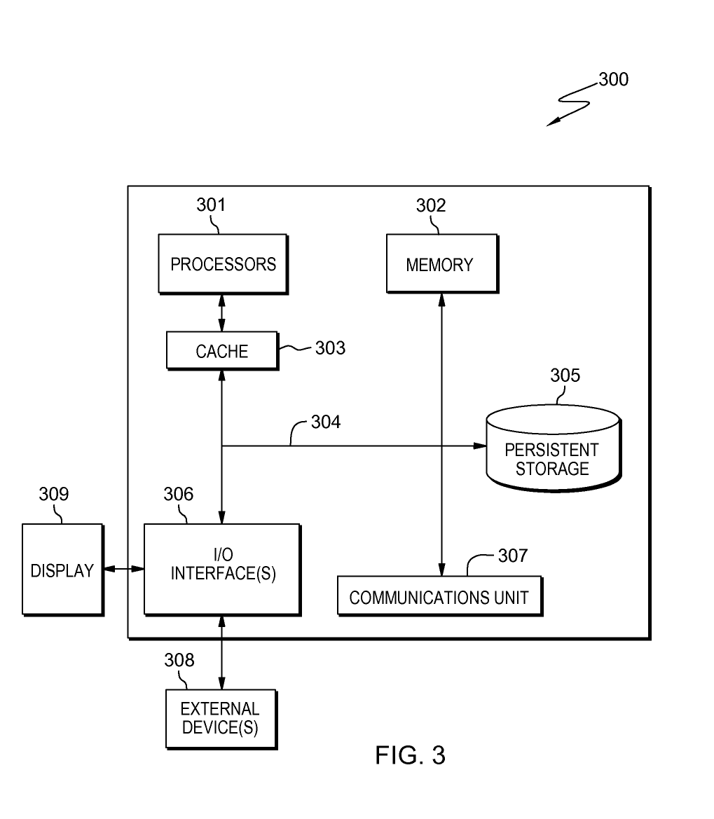

In example embodiments, computing device 110 can be a laptop, tablet, or netbook personal computer (PC), a desktop computer, a personal digital assistant (PDA), a smart phone, or any programmable electronic device capable of communicating with any computing device within data processing environment 100. In certain embodiments, computing device 110 collectively represents a computer system utilizing clustered computers and components (e.g., database server computers, application server computers, etc.) that act as a single pool of seamless resources when accessed by elements of data processing environment 100, such as in a cloud computing environment. In general, computing device 110 is representative of any electronic device or combination of electronic devices capable of executing computer readable program instructions. Computing device 110 can include components as depicted and described in further detail with respect to FIG. 3, in accordance with embodiments of the present invention.

Computing device 110 includes food program 112 and information repository 114. Food program 112 is a program, application, or subprogram of a larger program for managing food portion sizes. In an alternative embodiment, food program 112 may be found on any other devices connected to network 102 to manage food portion sizes of a user (i.e., customer) of computing device 110. Information repository 114 includes information used by food program 112 for managing food portion sizes and may include information about machine learning models for managing food portion sizes and attributes that are used in said models. In an alternative embodiment, information repository 114 may be found on any other devices connected to network 102.

In an embodiment, food program 112 is a program, application, or subprogram of a larger program for managing food portion sizes. In other words, food program 112 may determine a size of food portion for a customer using a machine learning model and based on the food waste (i.e., remaining food portion) when the user is done consuming the food, food program 112 may update the machine learning model. In an embodiment, food may be any solid or liquid that may be consumed. In an embodiment, the customer may be a single user. In an alternative embodiment, the customer may be a group of customers (i.e., all customers at a restaurant). Food program 112 determines a customer to determine the size of food portion for. Food program 112 then determines attributes related to the customer regarding the size of food portion the customer may eat. Food program 112 then determines the size of food portion for the user based on the attributes using a machine learning model. Food program 112 then determines the size of the food waste after the customer has finished consuming the food. Food program 112 updates the machine learning model based on the size of the food waste and the attributes of the customer.

A machine learning model includes the construction and implementation of algorithms that can learn from and make predictions on data. The algorithms operate by building a model from example inputs in order to make data-driven predictions or decisions, rather than following strictly static program instructions. In an embodiment, the model is a system which explains the behavior of some system, generally at the level where some alteration of the model predicts some alteration of the real-world system. In an embodiment, a machine learning model may be used in a case where the data becomes available in a sequential fashion, in order to determine a mapping from the dataset to corresponding labels. In an embodiment, the goal of the machine learning model is to minimize some performance criteria using a loss function. In an embodiment, the goal of the machine learning model is to minimize the number of mistakes when dealing with classification problems. In yet another embodiment, the machine learning model may be any other model known in the art. In an embodiment, the machine learning model may be a SVM “Support Vector Machine”. In an alternative embodiment, the machine learning model may be any supervised learning regression algorithm. In yet another embodiment, the machine learning model may be a neural network.

A user interface (not shown) is a program that provides an interface between a user and food program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, information repository 114 may include information about a standard machine learning model that can be applied on an ongoing basis. In an embodiment, the standard machine learning model is trained from the interaction with all previous customers of food program 112. In an alternative embodiment, information repository 114 may include multiple machine learning models, where each machine learning model is for a specific customer or group of customers and the machine learning model has been updated for the interaction of each specific customer the machine learning model is associated with. In an embodiment, information repository 114 may include information about a customer or a group of customers related to food portions. The information may include previous portion serving size, previous portion waste size, the time of the year the food is consumed, the temperature in the room when the food is consumed, the temperature outside when the food is consumed, the weather when the food is consumed, the ingredients in the food consumed, gender of the customer consuming the food, age of the customer consuming the food, weight of the customer consuming the food, height of the customer consuming the food, physical activity of the customer consuming the food, dish type the customer is consuming, location where the customer is consuming food, restaurant where the customer is consuming food, demographics of the restaurant location where the food is being consumed, cuisine served by the restaurant that is serving the food being consumed, time of the day the food is being consumed, noise level in the room the food is being consumed, light level in the room the food is being consumed, music being played in room the food is being consumed, or number of customers in the restaurant the food is being consumed, ingredients in the food being consumed, or nutrient information of the food being consumed (e.g., proteins, carbohydrates, fats, etc.).

Information repository 114 may be implemented using any volatile or non-volatile storage media for storing information, as known in the art. For example, information repository 114 may be implemented with a tape library, optical library, one or more independent hard disk drives, or multiple hard disk drives in a redundant array of independent disks (RAID). Similarly, information repository 114 may be implemented with any suitable storage architecture known in the art, such as a relational database, an object-oriented database, or one or more tables.

FIG. 2 is a flowchart of workflow 200 depicting operational steps for managing food portion sizes, in accordance with an embodiment of the present invention. In one embodiment, the steps of the workflow are performed by food program 112. In an alternative embodiment, steps of the workflow can be performed by any other program while working with food program 112. In an embodiment, food program 112 can invoke workflow 200 upon a user requesting a food portion size for a customer. In an alternative embodiment, food program 112 can invoke workflow 200 upon a user updating any part of the machine learning model or information found in information repository 114.

Food program 112 determines a customer (step 205). In other words, food program 112 receives an indication from a user, via a user interface discussed previously, of a customer that the user wants food program 112 to determine a food portion for. In an embodiment, the customer may be a single customer. For example, customer “A” at a restaurant orders meal “A” and user “A” (e.g., the waiter or waitress), indicates to food program 112 that customer “A” has ordered meal “A” and that the user wants food program 112 to determine the portion size of meal “A” for customer “A”. In an alternative embodiment, the customer may be all customers at a location. For example, manager “B” at restaurant “B” indicates to food program 112 to determine the food portion sizes for all customers that consume meals at restaurant “B”. In yet another embodiment, the customer may be a segment of people. For example, owner “C” of restaurant chain “C” indicates to food program 112 to determine the food portion size for all male customers that consume meals at restaurant chain “C”.

Food program 112 determines the attributes (step 210). In other words, food program 112 determines attributes needed to determine the food portion size for the determined customer. In an embodiment, food program 112 may determine the attributes from information stored in information repository 114. In an alternative embodiment, food program 112 may query the user for information to determine the attributes. For example, food program 112 may ask User “A” the current weather information in the area the food portion will be served to customer “A”. In another alternative embodiment, food program 112 may communicate with external services (not shown) to determine the attributes. In an embodiment, the attributes may include previous portion serving size, previous portion waste size, the time of the year the food is consumed, the temperature in the room when the food is consumed, the temperature outside when the food is consumed, the weather when the food is consumed, the ingredients in the food consumed, gender of the customer consuming the food, age of the customer consuming the food, weight of the customer consuming the food, height of the customer consuming the food, physical activity of the customer consuming the food, dish type the customer is consuming, location where the customer is consuming food, restaurant where the customer is consuming food, demographics of the restaurant location where the food is being consumed, cuisine served by the restaurant that is serving the food being consumed, time of the day the food is being consumed, noise level in the room the food is being consumed, light level in the room where the food is being consumed, music being played in room the food is being consumed, number of customers in the restaurant where the food is being consumed, ingredients in the food, or nutrient information of the food (e.g., proteins, carbohydrates, fats, etc.).

Food program 112 determines the food portion (step 215). In other words, food program 112 uses the machine learning model and the attributes determines previously to determine the food portion size for the customer. In an embodiment, food program 112 may use the standard machine learning model (i.e. a machine learning model that is used for a large group of people) that applies to all customers. In an alternative embodiment, food program 112 may use an updated machine learning model that is specific to the customer that the food portion is being determined for. In yet another alternative embodiment, food program 112 may use a machine learning model that includes information related to multiple customer groups (i.e., multiple restaurants, multiple catering services, multiple food service locations, etc.) The updated machine learning model has been updated based on previous food portion predictions by the machine learning model and responses from the user as to the remaining food waste after those portions were consumed. In an embodiment, food program 112 may determine the food portion size based on the weight of the food portion, volume of the food portion, area of the food portion on the serving device, number of food items (e.g., a protein food item and two side items), number of units of specific food items (e.g., two eggs, four pieces of toast, etc.), etc. For example, food program 112 may determine that customer “A” should be served a twelve ounce steak based on the attributes of customer “A”. The attributes of customer “A” include that customer “A” consumes less food when the temperature is higher than 80 degrees Fahrenheit, that the current temperature where customer “A” is consuming the food is 85 degrees Fahrenheit, customer “A” is male, male customers eat larger portions, customer “A” is 6′3″ in height, and customers that have a height higher than 6′0″ eat smaller portions. In another example, food program 112 may determine that all customers at Restaurant “B” should be served portion sizes ten percent smaller than the “standard” portion size based on the attributes of all customers at Restaurant “B”. In an embodiment, the “standard” portion size may be a size that is determined by a user at an initial setup of food program 112 and the machine learning model for a customer and then the a portion size based on the attributes and the customer may be determined relative to the “standard” portion size.

In an embodiment, the determined food portion may be served to the customer on a serving device that is associated with the customer. In other words, the serving device is specific to the customer so the consumption of the food portion may be monitored and recorded. In an embodiment, the serving device may have a form of identification. In an embodiment, the serving device identification may include any type of numbering, RFID (radio-frequency identification), barcode, manual input of customer id based on seating location of customer, etc., that is used to associate the serving device with the customer. The determined food portion, discussed previously, is served on the serving device of the customer. In an embodiment, the serving device identification may be integrated with a point of sales system to map the serving device identification to a customer.

Food program 112 determines food waste (step 220). In other words, food program 112 determines the size of food remaining on the serving device after the customer finishes consuming the food portion determined previously. In an embodiment, food program 112 may determine the food waste size based on the weight of the leftover food, volume of the leftover food, area of the leftover food on the serving device, etc. In an embodiment, the food waste size may be determined using a visual apparatus (i.e., camera, video camera, etc.), a weighing apparatus (i.e. scale, etc.), or the like. Food program 112 may determine the food waste and using the serving device identification, associate the food waste with the customer associated with the serving device identification. For example, food program 112 may determine that customer “A” has two ounces of steak waste on the serving device of customer “A” after customer “A” has finished consuming the food portion determined previously. In another example, food program 112 may determine that out of all customers at Restaurant “B” that are served determined food portions sizes, the average food waste on the serving device of the customer is fourteen percent of the food portion determined previously. In another example, an RFID scanner is attached to a waste container (i.e., garbage can) with a scale, customer “A” has finished consuming their meal, scans the serving device at the RFID scanner, disposes of the trash in the garbage, food program 112 determines the weight of the waste and food program 112 associates the waste with the user associated with the scanned serving device. In an embodiment, food program 112 may determine that there is no food waste. In an embodiment, food program 112 may determine that there is no food waste and that the customer requested another portion of food. In an embodiment, food program 112 may determine the food waste for the additional requested food portion and any subsequent requested additional food portions.

Food program 112 updates the model (step 225). In other words, food program 112 updates the machine learning model based on the determine food waste of the customer, the determined food portion served to the customer, and the attributes at the time of consumption of the determined food portion by the customer. In an embodiment, food program 112 may update the machine learning model based on no food waste. In an embodiment, food program 112 may update the machine learning model based on the customer requesting another portion of food (i.e. adjusting the machine learning model to indicate the customer needed a larger portion). In an embodiment, food program 112 updates the standard machine learning model used for all customers. In an alternative embodiment, food program 112 updates the machine learning model specific to the customer that the food portion was determined for.

In a scenario, food portions may be adjusted in a restaurant chain based on the location of the restaurant chain. The average waste per meal is analyzed for each meal on the menu and the portion size may be adjusted. The portion size may be adjusted by location or customer. A machine learning algorithm predicts waste based on the time of the year and/or the current weather and may be a support vector machine model that includes features for time of the year, temperature, and weather.

In a scenario, food portions may be adjusted in a single restaurant based on a customer identification. A machine learning model may learn what ingredients a customer may waste the most and what the predicted waste ratio is for a dish featuring specific ingredients. Additionally, in an embodiment, there may be a scaling factor for a given customer related to a specific ingredient. In other words, the amount of a specific ingredient to be used for a customer may be in a range.

In a scenario, the portions may be adjusted in multiple restaurants based on a customer identification. Each restaurant can access customer data from other restaurants that use similar reservation management system (i.e., web based restaurant reservation systems, application based restaurant reservation systems, etc.). In this scenario, the portion size may be estimated at a restaurant for a customer who has not previously visited the specific restaurant.

FIG. 3 depicts computer 300 that is an example of a computing system that includes food program 112. Computer 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing food portion sizes, the method comprising the steps of:
determining, by one or more computer processors, one or more attributes for a customer;
determining, by one or more computer processors, a food portion for the customer using a machine learning model and the one or more attributes;
determining, by one or more computer processors, a food waste for the customer; and
updating, by one or more computer processors, the machine learning model based on the food waste for the customer and the one or more attributes for the customer.

2. The method of claim 1, further comprising:
determining, by one or more computer processors, an additional food portion for the customer using the machine learning model and the one or more attributes, and
determining, by one or more computer processors, an additional food portion waste for the customer; and
updating, by one or more computer processors, the machine learning model based on the additional food portion waste for the customer and the one or more attributes for the customer.

3. The method of claim 1, wherein the one or more attributes is at least one of: a previous portion serve size and a previous portion waste size.

4. The method of claim 1, wherein the one or more attributes is at least one of: a time of a year the food portion is consumed, a temperature in a room when the food portion is consumed, a temperature outside when the food portion is consumed, a weather when the food portion is consumed, at least one ingredient in the food portion, a dish type of the food portion, and at least one nutrient information of the food portion.

5. The method of claim 1, wherein the one or more attributes is at least one of: a gender of the customer, an age of the customer, a weight of the customer, a height of the customer, a physical activity of the customer, a location the customer is consuming the food portion, a restaurant the customer is consuming the food portion, demographics of the restaurant, a cuisine served by the restaurant, a time the food portion is being consumed, a noise level in a room the food portion is being consumed, a light level in a room where the food portion is being consumed, a music being played in a room the food portion is being consumed, and a number of customers in a restaurant where the food portion is being consumed.

6. The method of claim 1, wherein determining a food waste for the customer comprises:
receiving, by one or more computer processors, a food waste size from a device, wherein the food waste size is determined from the food waste on a serving device associated with the customer.

7. The method of claim 6, wherein the food waste size is at least one of: a weight of the food waste, a volume of the food waste, an area of the food waste.

8. A computer program product for managing food portion sizes, the computer program product comprising:
one or more computer readable storage media; and
program instructions stored on the one or more computer readable storage media, the program instructions comprising:
program instructions to determine one or more attributes for a customer;
program instructions to determine a food portion for the customer using a machine learning model and the one or more attributes;
program instructions to determine a food waste for the customer; and
program instructions for updating the machine learning model based on the food waste for the customer and the one or more attributes for the customer.

9. The computer program product of claim 8, further comprising program instructions, stored on the one or more computer readable storage media, to:
determine an additional food portion for the customer using the machine learning model and the one or more attributes;
determine an additional food portion waste for the customer; and
update the machine learning model based on the additional food portion waste for the customer and the one or more attributes for the customer.

10. The computer program product of claim 8, wherein the one or more attributes is at least one of: a previous portion serve size and a previous portion waste size.

11. The computer program product of claim 8, wherein the one or more attributes is at least one of: a time of a year the food portion is consumed, a temperature in a room when the food portion is consumed, a temperature outside when the food portion is consumed, a weather when the food portion is consumed, at least one ingredient in the food portion, a dish type of the food portion, and at least one nutrient information of the food portion.

12. The computer program product of claim 8, wherein the one or more attributes is at least one of: a gender of the customer, an age of the customer, a weight of the customer, a height of the customer, a physical activity of the customer, a location the customer is consuming the food portion, a restaurant the customer is consuming the food portion, demographics of the restaurant, a cuisine served by the restaurant, a time the food portion is being consumed, a noise level in a room the food portion is being consumed, a light level in a room where the food portion is being consumed, a music being played in a room the food portion is being consumed, and a number of customers in a restaurant where the food portion is being consumed.

13. The computer program product of claim 8, wherein the program instructions to determine a food waste for the customer comprise:
Program instructions to receive a food waste size from a device, wherein the food waste size is determined from the food waste on a serving device associated with the customer.

14. The computer program product of claim 13, wherein the food waste size is at least one of:
a weight of the food waste, a volume of the food waste, an area of the food waste.

15. A computer system for managing food portion sizes, the computer system comprising:
one or more computer processors;
one or more computer readable storage media; and
program instructions stored on the one or more computer readable storage media for execution by at least one of the one or more computer processors, the program instructions comprising:
program instructions to determine one or more attributes for a customer;
program instructions to determine a food portion for the customer using a machine learning model and the one or more attributes;
program instructions to determine a food waste for the customer; and
program instructions for updating the machine learning model based on the food waste for the customer and the one or more attributes for the customer.

16. The computer system of claim 15, further comprising program instructions, stored on the one or more computer readable storage media for execution by at least one of the one or more computer processors, to:
determine an additional food portion for the customer using the machine learning model and the one or more attributes;
determine an additional food portion waste for the customer; and
update the machine learning model based on the additional food portion waste for the customer and the one or more attributes for the customer.

17. The computer system of claim 15, wherein the one or more attributes is at least one of: a previous portion serve size and a previous portion waste size.

18. The computer system of claim 15, wherein the one or more attributes is at least one of: a time of a year the food portion is consumed, a temperature in a room when the food portion is consumed, a temperature outside when the food portion is consumed, a weather when the food portion is consumed, at least one ingredient in the food portion, a dish type of the food portion, and at least one nutrient information of the food portion.

19. The computer system of claim 15, wherein the one or more attributes is at least one of: a gender of the customer, an age of the customer, a weight of the customer, a height of the customer, a physical activity of the customer, a location the customer is consuming the food portion, a restaurant the customer is consuming the food portion, demographics of the restaurant, a cuisine served by the restaurant, a time the food portion is being consumed, a noise level in a room the food portion is being consumed, a light level in a room where the food portion is being consumed, a music being played in a room the food portion is being consumed, and a number of customers in a restaurant where the food portion is being consumed.

20. The computer system of claim 15, wherein the program instructions to determine a food waste for the customer comprise:
program instructions to receive a food waste size from a device, wherein the food waste size is determined from the food waste on a serving device associated with the customer.
